(19) United States
(12) Patent Application Publication
(10) Pub. No.: US 2003/0051476 A1
(43) Pub. Date: Mar. 20, 2003

(54) Power system

(76) Inventor: Matthew E. Reno, Desert Hot Spring, CA (US)

Correspondence Address: Matthew E. Reno, 15253 Avenida Monteflora, Desert Hot Springs, Riverside, CA, 92240-7011, US

(21) Appl. No.: 09/682,558

(22) Filed: Sep. 19, 2001

(51) Int. Cl. F03G 6/00; F03G 7/00; B60L 8/00; B60K 16/00

(52) U.S. Cl. 60/641.8; 60/641.11

(57) ABSTRACT

A power module system that uses an electric motor and a turbine generator motor in combination to create a power generating loop. In this power-generating loop the user may not only generate their own power, but also generate excess power that can be sold back to the power company. On the large scale the loop starts with a pair of fuse boxes in a home or office with one fuse box hooked to the grid. The present invention uses a power storage base to start the self-running system and a fuse box to run electric motor that uses low power and increases power for the residence or office.

### BACKGROUND OF INVENTION

In the United States, and most industrialized nations, the citizens take electricity for granted. We use electricity to run things we consider essential, such as our furnaces, air conditioners, water heaters, and refrigerators. Hospitals and care facilities rely on local power facilities to keep patients at steady levels during operations, or when patients are not able to function on their own. Hospitals are required to have a back up power system that is not reliant on the power grid, however residences and offices are not required to have alternate power supply and usually have no power source other than the local utilities grid. With the recent brown outs and black outs in California the need for reliable secondary power sources has escalated to a major national problem.

The use of solar panels has grown in popularity, in the United States and around the world, as a means to enhance or replace the electricity from the local power grids. Solar panels can store a certain amount of power per cell, but the storage space is limited, and most solar systems require either large amounts of sunlight or large amounts of solar cells. Therefore, there are areas of the country in which solar cells are impractical due to low amounts of sunlight. Also solar panels are difficult to repair, costly to install, and replace, and relaying the stored current requires additional equipment.

The use of windmills as a power source has also been investigated and implemented in some parts of the United States. An inherent problem in wind driven power is the lack of wind, and the amount of space required for a windmill. Hydroelectric power is also used in some communities. The inherent problems in the use of hydroelectric power is the need for a large amount of running water, and the ability to harness the power with use of dams or other blockages. Also, the cost is prohibitive for an individual homeowner to gain access to, and build the necessary structures to capture the power.

Also used in many communities is a nuclear power plant. Nuclear power plants require detailed facilities to contain the nuclear reactions, can only safely function for a period of a few decades before a new plant must be built, and of course nuclear technology is out of the grasp of the average home or business owner for individual use. Other means of producing power have also been in use in the past, but are being phased out due to environmental concerns, i.e. coal burning.

U.S. Pat. No. 6,066,898 issued to Jensen on May 23, 2000 shows a microturbine power generating system including variable speed gas compressor. Jensen''s invention is unlike the present invention because it is intended to use natural gas compression to run a turbine, it is an advanced combustion system for processing gases to create energy, and it does not provide a system that could safely be used to power a home due to emissions. Also its primary intention is to be used in systems that currently run on gasoline power not standard electricity.

U.S. Pat. No. 5,845,479 issued to Nakhamkin, et al., on Dec. 8, 1998 shows a method for providing emergency reserve power using storage techniques for electrical systems applications. Nakhamkin''s invention is unlike the present invention because it is a power storage system intended for power plants, it is not intended to be a breaker system for individual residences or offices, and is concerned primarily with the ability of the turbine to fluctuate and provide particular amounts of emergency power in a certain amount of time.

U.S. Pat. No. 5,678,647 issued to Wolfe, et al., on Oct. 21, 1997 shows a fuel cell powered propulsion system. Wolfe''s invention is unlike the present invention because it is a fuel cell to convert a type of combustible fuel into DC for the electric motor. Wolfe''s invention does not provide for a means of providing electric current to an entire electrical system of a home or office, or to create power for a power grid system. Instead, Wolfe''s invention is intended for a small fuel combustion environment such as an automotive or maritime engine.

U.S. Pat. No. 5,482,791 issued to Shingai, et al., on Jan. 9, 1996 shows a fuel cell/gas turbine combined power generation system and method for operating the same. Shingai''s invention is unlike the present invention because it is a fuel turbine that produces a high density hydrogen gas through conversion, it must be run on some type of combustible fuel, it requires exhaust due to the combustion, and is intended to be an improvement on a known gas combustion engine, not to power a home or office, or to produce power for an established utilities grid.

U.S. Pat. No. 4,059,770 issued to Mackay on Nov. 22, 1977 shows an uninterruptable electric power supply. Mackay''s invention is unlike the present invention because it uses a gas turbine and an electric motor attached to the power grid to create power, it is not intended to be a power source for a home or office, and does not describe a means for re-circulating power back through to the power grid.

Consumers have tried to achieve power systems independent of the power grids, and cleaner energy in the past. However as is shown in the discussion of related art, the solution to this problem has not been achieved. Therefore a need has been established for a power generating system that can be installed in homes or offices that creates a steady supply of energy, does not require the power grid, but can be linked to the grid to supply the home or office and feed back into the grid for others use.

### SUMMARY OF INVENTION

The present invention is a power module system that uses an electric motor and a turbine generator motor in combination to create a power increase generating-loop. In this power-generating loop, the user may not only generate their own power, but also generate excess power that can be sold back to the power company. On the larger scale the loop starts with a pair of fuse boxes in a home or office.

The out fuse box is wired to run 120 volts and 15 amps, and is connected to the conventional power grid supplied by the local utilities company. The fuse box is then connected to an electric motor that is 15 volts, 8 amps and 920 watts or more. The RPM''S generated from the electric motor are then funneled through a conventional transmission to properly regulate the amount of RPM''S sent to the turbine generator motor. Once the turbine generator motor has received the RPM''S from the transmission, the power is run though #4 AWG line to the power base storage unit. Along this line the power is converted from AC (alternating current) to DC (direct current) before reaching the power base storage.

The power storage base then sends the power through an inverter, which converts the power from DC to AC. If the turbine generator is DC there is no need to convert the power from DC to AC. If the generator is AC the power can be redirected to the home or office fuse box. A system of 120-220 volts can be stored in the base by converting to 48 volts. From the inverter the power runs to the in fuse box, which is not connected to the grid, and runs all appliances in the building requiring power to operate.

In an alternate embodiment, if the power base storage is fully charged upon start up, the out or initial fuse box, and the power grid are not needed to start the system. The system continually re-powers itself, so therefore with a fully charged power storage base initially, there is no need for connection to local utility grids. The power storage base is initially fully charged, as it is a series of batteries that come charged from the manufacturers. Also alternately, a solar panel (optional) can be attached in conventional manner to the roof of the building that can create the initial power needed to start or run electric motor. It can also act as a feed to initially charge power storage base. Additionally, if the user chooses they may feed power back into the grid that is not being consumed by their household. The feed back of power to the grid is accomplished in the same manner as conventional existing solar energy technology. In this manner the user is supplying the power companies with additional power and creating a virtually self-sufficient power loop in the building in which it is installed. Also the user could set up this system independent of a need for power and continually feed a local power grid with a steady stream of voltage.

### BRIEF DESCRIPTION OF DRAWINGS

FIG. 1 shows a chart of a home with a version of the present invention installed.

FIG. 2 shows a small scale prototype of a possible embodiment of the present invention.

FIG. 3 shows a small scale prototype of a possible embodiment of the present invention.

### DETAILED DESCRIPTION

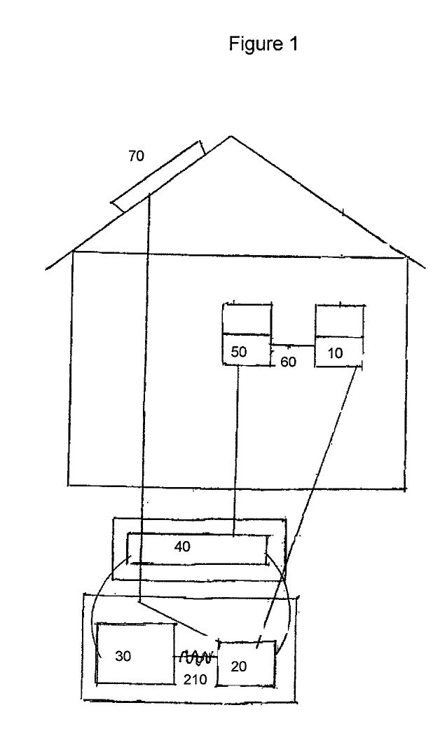

Turning to FIG. 1 we have a chart view of the invention as installed in a home or office. The out breaker box (10) is connected to the grid of the local utilities company (not shown). In this example the out breaker box (10) handles 120 volts, and 15 amps. Through a series of wiring techniques the out breaker box (10) is then connected to the electric motor (20). The wiring used in the present invention is # 12 AWG to number #2 AWG depending on the size of the motor, size of the power storage base, and of the unit. In this embodiment of the present invention the electric motor (20) is 110-115 volts to 8 amps or more. The out breaker box (10) using the power supplied by the local utility grid (not shown) supplies the initial start up power for the electric motor (20). The electric motor (20) receives the power in AC or alternated current form. The electric motor (20) can alternate the current that is output to the turbine (30), during periods of low or high usage. However, the electric motor (20) can also continue to run at high RPM at all times and feed any unused current back into the power grid. A generator motor (30) will need speeds of 1500-3000 RPMs. Windmill turbines are intended to run on a low RPM basis going through a transmission facilitated by the wind, however variance in wind speed requires batteries for steady power production. The present system keeps the RPMs steady.

The generator turbine motor (30) functions at 5,000 watts and up and then feeds via a series of wiring to a power storage base (40). The power storage base (40) feeds via #4 AWG wiring to the in breaker box (50). The in breaker box (50) feeds the household appliances and needs of the building. The in breaker box (50) is attached through the wire (60) to the out breaker box (10), which feeds excess power back into the power grid.

Alternately, there is a solar panel (70) that can run or start the electric motor (20), thereby eliminating the need for the out breaker box (10). If the power storage base (40) is fully charged it can alternately start the electric motor (20). The solar panels (optional) (70) would be designed to fit the power needs of an electric motor. There is a switch (not shown) that can initiate power delivery from the power storage base. The maintenance of the present invention is minimal, with the exception of replacement of batteries and occasional maintenance of motor (20), transmission (210) and generator (30). This invention is environmentally friendly. It is clean and does not pollute by burning fossil fuels or natural gas.

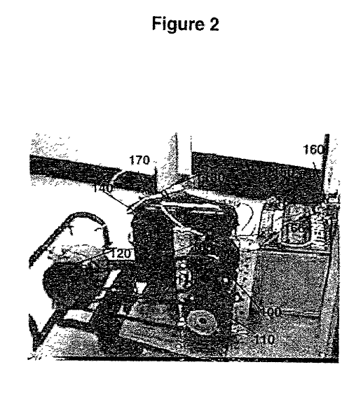

A miniature prototype of this invention has been built. It can be used in travel, or as an appliance to use in situations of brief black out, or brown out of power. As is shown in FIG. 2, there is a small power generating system with two twelve-volt electric motors (100, 110). Each of the two twelve volt motors (100,110) outputs 15 amps, so there is a steady output of 30 amps. The motors (100, 110) are connected by a pair of belts (105,115) to an alternator (120). The alternator (120) outputs 14 to 15 volts, which can run any conventional appliance of the correct voltage for the lead battery (140). The alternator (120) is also attached to the lead battery (140) that is in this example a 12-volt battery. The lead battery (140) is continuously charged by the alternator (120) but cannot be overcharged due to a conventional regulating function in the alternator (120). There is also a second small 120 Volt prototype, inverting 12 Volts to 120 Volts using 115 Volts motor.

The two twelve volt motors (100, 110) are connected by wiring to a start up battery (150). The start up battery (150) provides the initial power to start the power loop. The start up battery (150) is of the same voltage as the lead battery (140). The alternator (120) can be inverted to a 24-volt, 36-volt, or 48 volt system as long as the lead battery (140) and electric motors (100, 110) match in voltage. The two electric motors (100, 110) can be condensed in other embodiments of the present invention to one motor (not shown) of the correct voltage to match the lead battery. There is also a switch (170) attached to the lead battery (140), which can be used to start the system initially. The system can also be configured to provide all power directly from the alternator (120) without the use of the lead battery (140). On the system shown in FIG. 2, anything that can be run from a twelve volt system can be used, i.e. a car vacuum, a video camera, cellular phones, etc.

The present invention could also be used in electric cars to continuously charge the car, to allow the user to eliminate the need for overnight charging. For example if the electric car is 36 volts then a 36 volt generator is needed. The motor will, in this example, need 6-6 volt batteries in the power storage base. With the motor running the generator, the motor will take in 50 amps, and the generator needs to produce more power than the motors need. The electric car motor start up is at 200 amps, and then decreases down to 10-25 amps, the generator needs to output a consistent 150 amps, and at that rate can continually recharge itself while traveling or standing still.

The current technology in the efficiency of electric motors, generator turbines and inverters/converters is such that what would not work ten years ago, works today. The future is unlimited.

When the system as in FIG. 2 is in use the alternator (120) keeps the lead battery (140) at a slightly variant charge of 12.9 to 13.0 volts, which is well within safe output for the lead battery (140) and the start up battery (150).

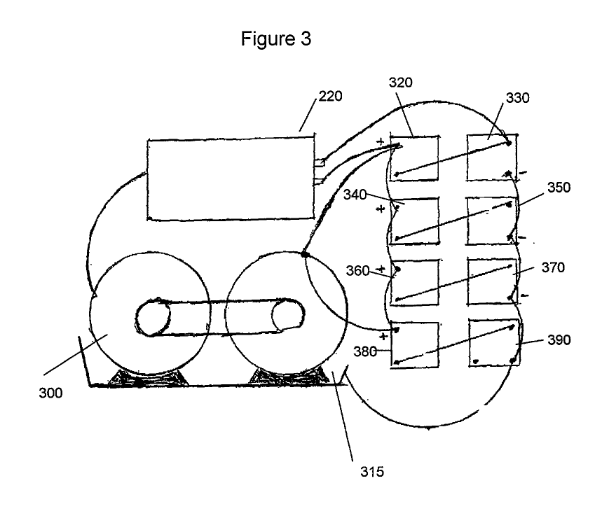

FIG. 3, shows a third possible embodiment of the present invention. Inherent in the prototype is an inverter (220). The inverter (220) is 1500 watts, with an initial start up surge of 3000 watts and takes 10 amps per 100 watts. The inverter (220) inverts 12 volts into 110 output. The alternator (315) can be 12 volt, 130 amp, and running at 3000 RPM; it outputs 14 volts and 1,820 watts. The motor (300) in this embodiment is 110 volts, with 10.5 amps or with load 11.5 amps. The motor (300) runs at 3450 RPM, or with load 3000 RPM. The motor is a “heavy duty” type motor.

There is a storage base having eight 6 volt batteries (320, 330, 340, 350, 360, 370, 380, 390) which are arranged so that they are crossed over positive to negative in pairs, and then the pairs are arranged with a straight positive run and straight negative run to keep a continuous 12 volt system to get 840 AMP hours. Because this embodiment has a larger alternator (315), an inverter (220), one motor (300), and eight 6 volt batteries (320, 330, 340, 350, 360, 370, 380, 390), the user can run typical household appliances.

The present invention is not limited to the sole embodiments above but encompasses any and all of the embodiments in the following claims.

1. An utility usage system for a home, comprising:
at least one electric motor;
a generator turbine, communicating with said at least one electric motor;
a power storage base, communicating with said generator turbine and said at least one electric motor; and
a first breaker box, communicating with said power storage base and the home.

2. An utility usage system as in claim 1, further comprising a second breaker box in communication with a power source.

3. An utility usage system as in claim 1, wherein said at least one electric motor can be of any conventional voltage.

4. An utility usage system as in claim 1, further comprising an alternator connected by belts to said at least one electric motor.

5. An utility usage system as in claim 1, wherein said power storage base has a series of batteries which are connected to one another.

6. An utility usage system as in claim 1, further comprising an inverter for converting current from directed current to alternated current, said inverter communicating with said power storage base and the home.

7. An utility usage system as in claim 2, wherein electricity that has been generated in the home and is unused moves from said first breaker box to said second breaker box.

8. An utility usage system as in claim 1, further comprising a transmission regulating output from said at least one electric motor to said generator turbine.

9. An electricity generating method for a local environment, comprising:
a means for producing electricity in the local environment; and
a means for feeding extra electricity to an utility grid.

10. An electricity generating method for a local environment, comprising:
at least one solar panel in direct communication with an electric motor; and
a means for producing electricity in the local environment, with the initial start up from said at least one solar panel.

11. An electricity generating method for a local environment as in claim 10, wherein said at least one solar panel provides a means for initial start up of said means for producing electricity without the use of electricity from an utility grid.
